(19) United States
(12) Patent Application Publication
(10) Pub. No.: US 2010/0044280 A1
(43) Pub. Date: Feb. 25, 2010

(54) Flotation Process Using an Organometallic Complex as Activator

(75) Inventors: Dawid Marthinus Louis Viljoen, Klerksdorp (ZA); Leon Lubbe, Potchefstroom (ZA)

Correspondence Address: GROSSMAN, TUCKER, PERREAULT & PFLEGER, PLLC, 55 SOUTH COMMERICAL STREET, MANCHESTER, NH, 03101, US

(73) Assignee: KIMLEIGH CHEMICALS SA (PTY) LTD, Potchefstroom (ZA)

(21) Appl. No.: 12/162,104

(22) PCT Filed: Jan. 23, 2007
(86) PCT No.: PCT/IB2007/050228

§ 371 Date: Nov. 19, 2008

(30) Foreign Application Priority Data
Jan. 24, 2006 (ZA) 2006/00927

(51) Int. Cl. B03D 1/008; B03D 1/001; B03D 1/014; B03D 1/012; B03D 1/01; B03D 1/002; B03D 1/02

(52) U.S. Cl. 209/167; 252/61; 209/166

(57) ABSTRACT

The invention provides a flotation process which includes the steps of providing a flotation mixture containing mineral values to be recovered and adding an activator to the flotation mixture, which activator may comprise a metal complex formed by a coordinating metal ion and a ligand. A particular aspect of the invention relates to the use of the metal complexes as activators. These complexes are stable over a wide pH range, which is not the case with other inorganic compounds of which the applicant is aware, such as zinc sulphate, copper sulphate and manganese sulphate. The ligand may have the structure R—(X)ₙ, in which X may be selected from amines, carboxyls, phosphonates and sulphonates; R may be an organic group; and n may be 1 to 4. The ligand may be selected to be a multidentate ligand. The invention extends to an activator for use in a flotation process.

### FIELD OF THE INVENTION

This invention relates to a froth flotation separation process and activators for such a flotation process. More particularly, this invention relates to froth activators which may be used as modifiers or promoters of froth flotation processes.

### BACKGROUND OF THE INVENTION

The applicant is aware that activators such as copper sulphate are used in ore flotation separation processes. Such activators function by selectively binding to the surface of a metal in the ore to become either hydrophobic, to be separated with the froth, or hydrophilic, to be separated with the aqueous phase. However, in the case of copper sulphate, the resultant cupric ions only remain in solution in an acidic environment and precipitate out in a basic environment, which renders the activator potentially useless at a basic pH.

### SUMMARY OF THE INVENTION

According to a first aspect of the invention there is provided a flotation process which includes the steps of:

in a minerals recovery plant, providing a flotation mixture containing mineral values to be recovered and;

adding an activator to said flotation mixture, which activator may comprise a metal complex formed by a coordinating metal ion and a ligand.

A particular aspect of the invention relates to the use of the metal complexes as activators. These complexes are stable over a wide pH range, which is not the case with other inorganic compounds of which the applicant is aware, such as zinc sulphate, copper sulphate and manganese sulphate.

The method includes the step of forming an activator complex prior to addition to the flotation process or adding individual components that will form an activator complex in situ.

The coordinating metal ion may be selected from any known activator metals used in flotation processes. The activator metal may be copper, nickel, manganese, zinc or the like.

The ligand may have the structure R—(X)ₙ, in which:

X may be selected from amines, carboxyls, phosphonates and sulphonates;

R may be an organic group; and

n may be 1 to 4

The ligand may be selected to be a multidentate ligand.

The process may include the step of selecting a ligand which allows changes in a pH range to modify the charge or ionic nature of the ligand or complex, such that modifying the ligand charge or ionic nature may render it hydrophobic or hydrophilic as dictated by the flotation process requirements.

More particularly, the ligand may be selected from any one or more of: adipic acid, alanine, aspartic acid, adenosine triphosphate, citric acid, cysteine, dimethylglyoxime, EDTA, gluconic acid, histidine, lactic acid, pimelic acid, salicylic acid, triphosphate, monoethanolamine, triethanolamine, 1,2-propylenediamine, tartaric acid, fulvic acid, sulphonic acid, humic acid, combinations thereof, and the like.

In a preferred embodiment, the activated metal is copper and the ligand is citric acid. Accordingly, an activator of the invention may be copper citrate. The activator of the invention may be used in combination with copper sulphate in flotation reactions.

The molar ratio of ligand to metal ion may be in a range of 2:1 to 1:2, preferably about 1:1.

The process may include the step of selecting or adjusting the pH of the flotation mixture to change the hydrophobic or hydrophilic nature of the complex or to form a desired complex species.

Typical metals and minerals that could be recovered, separated and/or concentrated from the ores include:

Platinum Group Minerals (PGM) from Platinum bearing ores;

Copper, Zinc, Lead, Silver, Gold recovery and separation from polymetallic and other base metal ores;

Gold and Silver from gold bearing ores; or

Sulphide minerals from sulphide containing ores.

Such complexes keep the metal in solution over a wide pH range.

It will be appreciated that the invention provides an adaptable method whereby any one of a wide selection of metals to be recovered may be selectively activated or unwanted metals may be selectively suppressed or provide a combination of activation and suppression. Furthermore, the activator can be used with standard flotation equipment or plants without the need for modifications.

The activator may be added to the mixture in amounts ranging from 1 g activator per ton of ore to 1000 g activator per ton of ore to be processed, typically amounts ranging from 50 to 150 grams activator per ton of platinum bearing ore; amounts ranging from 150 to 250 grams activator per one ton of gold bearing ore; and amounts ranging from 5 to 100 grams activator per one ton of zinc bearing ore.

According to a further aspect of the invention, there is provided an activator for use in a flotation process, which activator comprises a coordinating metal ion and a ligand which forms a complex in water, as described above.

The activator may be a complex in an aqueous solution at a predetermined pH. The pH may be between pH 2 and pH 12, preferably about pH 4.

Further aspects of the invention will now be described, by way of example only, with reference to the accompanying drawings and examples.

### DRAWINGS

In the drawings:

FIG. 1 shows the effect of Activator 357 S20, an activator of the invention: Grade vs. Recovery Curves;

FIG. 2 shows the effect of Activator 357 S20: Rate Curves;

FIG. 3 shows a grade recovery curve from the test program of the copper chelate activator;

FIG. 4 shows a grade recovery curve from the test program of the copper chelate activator of the invention;

FIG. 5 shows a milling curve;

FIG. 6 shows reproducibility grade vs. recovery curves;

FIG. 7 shows kinetic curves with and without copper sulphate;

FIG. 8 shows scoping tests—grade vs recovery curves;

FIG. 9 shows the effect of activators of the invention: grade vs. recovery curves; and

FIG. 10 shows the effect of activators of the invention: kinetic curves.

### DETAILED DESCRIPTION OF THE INVENTION

The invention relates to useful activators and combinations of activators for froth flotation processes, which activator has several uses and benefits which include lower reagent consumption and a reduction in the addition rate and quantity of collector and depressant species. The function of a collecting reagent/collector species in a float process is to bind with the surface of the desired mineral thereby to render the mineral surface hydrophobic and aerophilic. This enables the desired mineral to attach to the air bubble, transporting said minerals to the surface or frothing zone of a float cell as a concentrate contained in the froth. Typical collecting reagents are from the xanthate family of compounds. These include: sodium ethyl xanthate, sodium isopropyl xanthate, sodium isobutyl xanthate, sodium amyl xanthate and other xanthate family chemicals. However, a characteristic of xanthate chemicals is that they usually form an insoluble compound with Cu²⁺ ions in solution, rendering the Cu²⁺ unavailable for the activation of sulphide and other desired minerals or metals in the ore.

Thus, if an excess of copper ions is added to compensate for the lower effectiveness caused by the resultant copper hydroxide formation at higher pH levels, the excess Cu²⁺ ions will bind with the added xanthate and remove the xanthate from solution in the form of CuXₙ precipitates, which is detrimental to the values recovery process.

Generally, the activator of the invention is produced by mixing a co-ordinating metal ion, such as copper, nickel, manganese, zinc. In one embodiment, copper sulphate is complexed with a molar equivalent of any one of the following ligands: adipic acid, alanine, aspartic acid, adenosine triphosphate, citric acid, cysteine, dimethylglyoxime, EDTA, gluconic acid, histidine, lactic acid, pimelic acid, salicylic acid, triphosphate, monoethanolamine, triethanolamine, 1,2-propylenediamine, tartaric acid, fulvic acid, sulphonic acid or humic acid, depending on the desired pH range. To each of these mixtures water is added and stirred until the mixture clears. Each of these mixtures may be used as an activator and remain in solution over a pH range of about 2 to 12.

The activator is made up to a concentration of between 2% and 30% m/m and added to the flotation process using reagent dosing pumps.

The activator may be added to many parts of the process, depending on the optimal requirements of each specific process. Typical addition points are either directly into mills, or into a conditioning tank prior to rougher floatation. Alternatively or addition, it can be added to a float section to enhance recovery e.g. in regrind mills, scavenger sections, cleaner sections, re-cleaner sections, and the like.

The flotation pH differs from mineral to mineral. In an example shown below, Platinum Group Minerals (PGM) were recovered at the natural pH of the ore, which ranged between an acid pH of 5 to 7 to an alkaline pH of 7 to 11. Other complex ores shown in the examples below made use of differential pH levels to recover the different concentrates. The activator stayed in solution over the range of pH conditions so as to be available to electrochemically react with the different mineral surfaces. A suitable collector was then added to render the desired metal or mineral particles hydrophobic, upon which the particles were removed in the floatation cell in the air bubbles and recovered as a metal or sulphide concentrate.

### EXAMPLE 1

The invention allows for the separate addition of chelating (ligand) product to mixtures already containing copper sulphate. The primary method of producing the copper chelated formulation is by adding the appropriate masses of copper ion and chelating agent as detailed in the embodiment together in a mixing vessel under the specified conditions to form the required compound.

The required compound can, however, also be formed by adding the appropriate masses of copper sulphate and chelating compounds in a dry form together and packing the resulting dry mix. This mix can now be either premixed with solutions which may include one or more solvents, including process water, clean water or any other solvent in a tank before adding the formulation to the flotation process. The mix can also be added in its solid form to the flotation process stream at any point from the dry unmilled ore to the slurry, at most points of the recovery process.

Another method of producing the copper sulphate and chelate compound is to dissolve dry powders of both products in a suitable solvent, such as water, and then to evaporate the solvent. This can again form homogenous compounds that can be packaged for use.

### EXAMPLE 2

In a particular embodiment, an activator of the invention was produced using copper sulphate pentahydrate and citric acid monohydrate. These two components were added on a 1 mol copper ions to 1 mol citric acid monohydrate basis, i.e. for 1 g of copper sulphate pentahydrate, which contains 0.25 g of Cu²⁺, 0.84 g of citric acid was added. The resulting copper citrate activator was termed Activator 357 S20

### EXAMPLE 3

Another method of the invention includes the steps of reacting copper sulphate with calcium citrate in a solvent. The result is that calcium sulphate forms, which is normally an insoluble precipitate which is then removed by filtration. The remaining solution contains copper citrate and the solution may be used as is or may be evaporated to form crystalline compounds.

A further method of forming the copper-chelated activator formulation is by adding the copper sulphate pentahydrate crystals to the process at any point as described previously, and by the addition of the dry chelating compound in a suitable ratio at any point to the process in any sequence. The chemicals can dissolve in the process solutions and can form the chelated copper compound. The copper sulphate and the chelating compound may also be dissolved separately in any solvent and added separately in solution form in any ratio to the process at any process point in any sequence.

### EXAMPLE 4

### Sample Preparation

Float tests were conducted on zinc ore slurry samples taken from a zinc flotation plant. The slurry sample had already been milled and the sample was similar condition as regular slurry when floated in a conventional flotation plant.

This float sample was mixed thoroughly and split into six different smaller and homogenous samples using a sample splitter. The samples had a volume of 2 l each and contained approximately 50% solids.

### Flotation Tests

The procedure that was followed for each of the six lab float tests was the same, with the exception that the amount and type of activator was varied in each of the six tests as discussed below.

### Lab Float Test Equipment

A Denver D-12 lab float machine, with variable rotation speed, was used with a 2.5 l float cell. A mass balance was used to weigh the samples and a graduated volumetric cylinder was used to measure the volume of the samples. A pneumatic press filter and Whatman filter paper was used to filter the float samples. An electric drying oven was used to dry the filtered samples. Stainless steel containers were used to collect the float samples.

### Lab Float Test Reagents

The collector (sodium ethyl xanthate), frother (M.I.B.C) and the reagents were the same grade as the reagents that are used in conventional float plants. The activators copper sulphate pentahydrate and the copper citrate activator of the invention (hereinafter referred to as Activator 357 S20) were made up from AR grade reagents.

### Lab Float Test Procedure

One of the small split samples of 2 l each was transferred into the 2.5 l float cell, following which it was agitated intensively in a Denver D-12 machine with the speed set at 900 rpm for 5 min. The rotation speed was increased to 1300 rpm and the reagents were then added and conditioned as specified in Table 1 below. Four concentrates were then collected over 0-1, 1-3, 3-7 and 7-20 minutes. All the products were filtered, dried and analyzed for zinc content.

TABLE 1
Standard reagent conditions

| | | Conditioning |
|---|---|---|
| | Dosage | Time |
| Reagent | (g/t) | (min) |
| Activator | 19 | 5 |
| Collector | 2.5 | 2 |
| Frother | 0.1 | 0.5 |

This procedure was repeated for each of the six float tests except that in the first float test, which was a blank/control run, no activator was added and that in run 3 to 6 the activator that was added was the activator of the invention (Activator 357 S20). The Activator 357 S20 was added on a mol basis equal to a fraction of the amount of copper that was added with the copper sulphate pentahydrate activator in run 2. For instance, 19 g of copper sulphate pentahydrate was added to run 2 of the zinc flotation tests, with an equivalent amount of copper citrate solution being added. To this end, 4.835 g Cu²⁺ (19 g CUSO₄-5H₂O) and 15.988 g citric acid was dissolved in water and then added to Run 3. This is a 100% equivalent viewed on a copper basis.

In runs 3 to 6 the amount of Activator 357 S20 that was added contained respectively 100%, 75%, 50% and 25% of copper, on a mol basis, of the amount of copper that was added in run 2.

TABLE 2
Amount of activator added to each float run.
Activator dosage

| Run | Amount of Activator (g/t) |
|---|---|
| 1 | 0 |
| 2 | 19 |
| 3 | 19 |
| 4 | 14.25 |
| 5 | 9.5 |
| 6 | 4.75 |

Table 3 shows a summary of the results of the abovementioned flotation tests

TABLE 3
Effect of Activator 357 S20.

| | | | | AqCua ™ Activator 357 S20 | | | |
|---|---|---|---|---|---|---|---|
| | | No Activator | CuSO4 | 100% | 75% | 50% | 25% |
| Recovery | Conc. 1 | 22.7 | 83.6 | 75.0 | 82.8 | 83.1 | 56.1 |
| (%) | Conc. 1 + 2 | 39.7 | 93.2 | 90.2 | 92.7 | 93.6 | 71.5 |
| | Conc. 1 + 2 + 3 | 54.0 | 95.2 | 93.9 | 94.9 | 96.0 | 77.8 |
| | Conc. 1 + 2 + 3 + 4 | 73.7 | 96.8 | 95.7 | 96.3 | 97.3 | 83.1 |
| Grade | Conc. 1 | 253000 | 338000 | 307000 | 305000 | 318000 | 247000 |
| (g/t) | Conc. 1 + 2 | 267260 | 300030 | 275153 | 275316 | 290316 | 243622 |
| | Conc. 1 + 2 + 3 | 265300 | 270109 | 248622 | 250807 | 260303 | 226850 |
| | Conc. 1 + 2 + 3 + 4 | 236877 | 223706 | 205857 | 204748 | 212434 | 189351 |

It is clear that much higher recovery was achieved with the use of Activator 357 S20 than compared with not using any activator. The overall recovery was increased in certain cases by 23.6%.

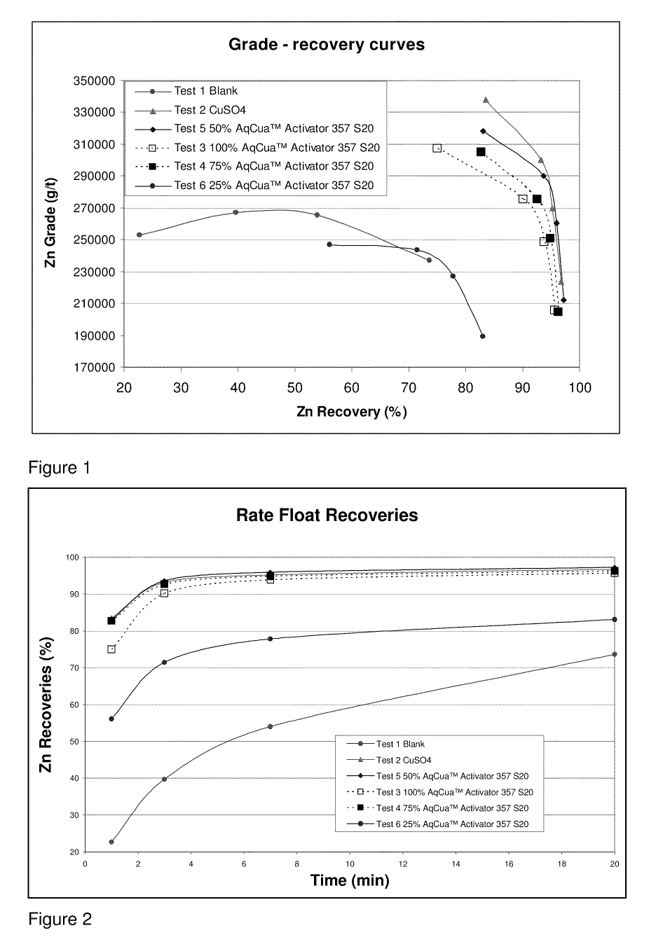

In the graph shown in FIG. 1, the grade recovery curve for all six the float tests can be seen. The graph shows that the Activator 357 S20 at 100%, 75% and 50% dosage provided good yields. Activator 357 S20 at 25% dosage, however, performed similar to the test sample to which no activator had been added.

FIG. 2 shows the kinetic rate curves of all the float tests. From these, it is evident that the Activator 357 S20 at 100%, 75% and 50% dosage performed similar to the normal copper sulphate and Activator 357 S20 at 25% dosage performed similar to the test with no activator.

From the results it is evident that Activator 357 S20 achieves similar recovery values and grades to copper sulphate. The kinetics of the flotation is also similar. It must, however, be born in mind that Activator 357 S20 achieved similar results even when the equivalent copper dosage was decreased to 50%. This means that dosing 50% of the equivalent activator achieves the same results as normal copper sulphate flotation reactions, which may have a beneficial cost implication for mining companies because of greatly reduced reagent requirements.

### EXAMPLE 5

The purpose of this section was to evaluate the performance of Activator 357 S20, at various concentrations, compared to the performance of copper sulphate in the flotation of gold and sulphur bearing ore from a gold mining operation.

### Sample Preparation

Slurry samples where collected from a gold mining operation in 25 l drums. The slurry samples were taken from the cyclone underflow upstream from the flotation plant. This means that the slurry sample had already been milled and that the sample was in the same condition as what the normal slurry would be when subjected to flotation. However, the density of the sample was higher than that of the slurry in the float plant feed. Process water from the plant was also collected in 25 l drums.

Twenty five litres of the slurry sample was poured into a stainless steel mixer. Some of the process water was added to the slurry sample to decrease the density. Samples from the mixer were taken regularly and the density of the samples was measured. Using this method the density of the float sample was reduced to 1360 kg/m³ which is equal to the typical density of the slurry that is used for flotation in the gold plant itself. This mixed float sample, with suitable density, was then split into six different samples using a sample splitter that was attached to the bottom of the stainless steel mixing tank. This process was repeated until six smaller and homogenous samples of 8 l each had been made up. These smaller samples were used for the flotation test work and were numbered A to F. The solids content of these samples were also determined and the average was 42.8% solids on a mass per mass basis.

### Flotation Tests

The procedure that was followed for each of the six lab float tests were the same, with the exception that the amount and type of activator was varied in each of the six tests.

### Lab Float Test Equipment

A Denver D-12 lab float machine, with variable rotation speed, was used with a 9 l float cell. A Mettler Toledo mass balance was used to weigh the samples and a graduated volumetric cylinder was used to measure the volume of the samples. A pneumatic press filter and Whatman filter paper were used to filter the float samples. An electric drying oven was used to dry the filtered samples. Plastic containers were used to collect the float samples.

### Lab Float Test Reagents

The frother (Dowfroth 200), collector (sodium isobutyl xanthate) and the activator (copper sulphate pentahydrate) were the same grade as the reagents that are used in the float plant of the mining operation. The activator of the invention, Activator 357 S20, was made up from AR grade reagents as described hereinbefore.

### Lab Float Test Procedure

One of the small split samples of 8 l each was transferred into the 9 l float cell. It was then agitated intensively in a Denver D-12 machine with the speed set at 900 rpm for 5 min. The rotation speed was increased to 1500 rpm and the reagents were then added and conditioned as specified in Table 4 below. Four concentrates were then collected over 0-1, 1-3, 3-7 and 7-20 minutes. All the products were filtered, dried and were analysed for gold and sulphur content.

TABLE 4
Standard reagent conditions

| | | Conditioning |
|---|---|---|
| | Dosage | Time |
| Reagent | (g/t) | (min) |
| Activator | 230 | 5 |
| Collector | 40 | 2 |
| Frother | 15 | 0.5 |

This procedure was repeated for each of the six float tests except that in the first float test, which was a blank run, no activator was added and in runs 3 to 6, the activator that was added was Activator 357 S20. The Activator 357 S20 was added on a mol basis equal to a fraction of the amount of copper that was added with the copper sulphate pentahydrate activator in run 2. In runs 3 to 6, the amount of Activator 357 S20 that was added contained, respectively, 100%, 75%, 50% and 25% of copper, on a mol basis, of the amount of copper that was added in run 2.

TABLE 5
Amount of Activator added to each float run.
Activator dosage

| | Amount of |
|---|---|
| Run | Activator (g/t) |
| 1 | 0 |
| 2 | 230 |
| 3 | 230 |
| 4 | 172.5 |
| 5 | 115 |
| 6 | 57.5 |

Table 6 shows a summary of the test results.

TABLE 6
Summary of float test results.

| | | | | Grade | Recovery |
|---|---|---|---|---|---|
| | Mass | | | Au | Au |
| Test | pull % | Grade S % | Recovery S % | (g/t) | (%) |
| Run 1 | 4.64 | 12.97 | 81.9 | 2.34 | 41.60 |
| Run 2 | 3.93 | 17.92 | 80.3 | 2.44 | 35.68 |
| Run 3 | 5.63 | 14.31 | 95.5 | 1.99 | 45.87 |
| Run 4 | 6.55 | 11.12 | 94.0 | 1.55 | 60.82 |
| Run 5 | 4.70 | 11.83 | 85.4 | 2.03 | 50.03 |
| Run 6 | 4.30 | 20.51 | 94.9 | 2.14 | 42.54 |

The results shown above indicate that when the Activator 357 S20 was added as the activator in the float test the recovery of sulphur improved dramatically, even compared to runs containing copper sulphate. Even when the Activator 357 S20 was added at only 25% of the copper dosage, in run 6, it still showed a large improvement of 13.0% in the recovery over the recovery of run 1 with no activator.

Similar results can be seen for the recovery of gold. There was a marked improvement from 41.60% recovery using no activator to the 60.82% recovery for the addition of 75% Activator 357 S20.

It is clear that better recoveries were obtained in runs done with Activator 357 S20 as the activator. In the abovementioned batch test, Activator 357 S20 improved the recovery and grade of sulphur and it should therefore be of use in improving the recovery and grading in a large scale plant application.

Surprisingly, it is also evident that using Activator 357 S20 as an activator instead of the more traditionally used copper sulphate showed significant increases in the recovery of gold. The improved recovery of gold and sulphur will most likely result in increased recovery and profitability for mining companies.

The results shown herein indicate that the formulations of the invention containing lower copper contents perform at least the same as would be the case with a conventional copper sulphate pentahydrate addition rate. The implication is that less copper is added, which results in lower excess copper addition rates, which would reduce the amount of xanthate precipitated with copper in the form of CuXₙ. The net effect is thus a reduction in the consumption of xanthate and other reagents, specifically activators and depressants when the stabilized copper chelate of the invention is used in the activation of minerals in the flotation process.

The invention has a further advantage in that it results in a reduction in the addition rate of frother in a flotation reaction. The function of a frother in the flotation process is to generate bubbles in the float cells containing air. These bubbles rise to the surface of pulp material in the flotation cell, carrying the hydrophobic components of the ore which is being subjected to the float process. Part of the hydrophobic components includes the desired mineral contained in the ore. The recovery efficiencies are determined partly by the mass of hydrophobic minerals delivered to the cell surface as a concentrate. This mass is controlled by the number and size of bubbles, which in part is controlled by the addition rate of the frother. When more mass is floated, the higher the recovery will be. This will, however, cause a lower purity of the desired mineral concentrate. When a higher mass is floated, desirable and undesirable minerals are recovered, hence the lower purity of the concentrate.

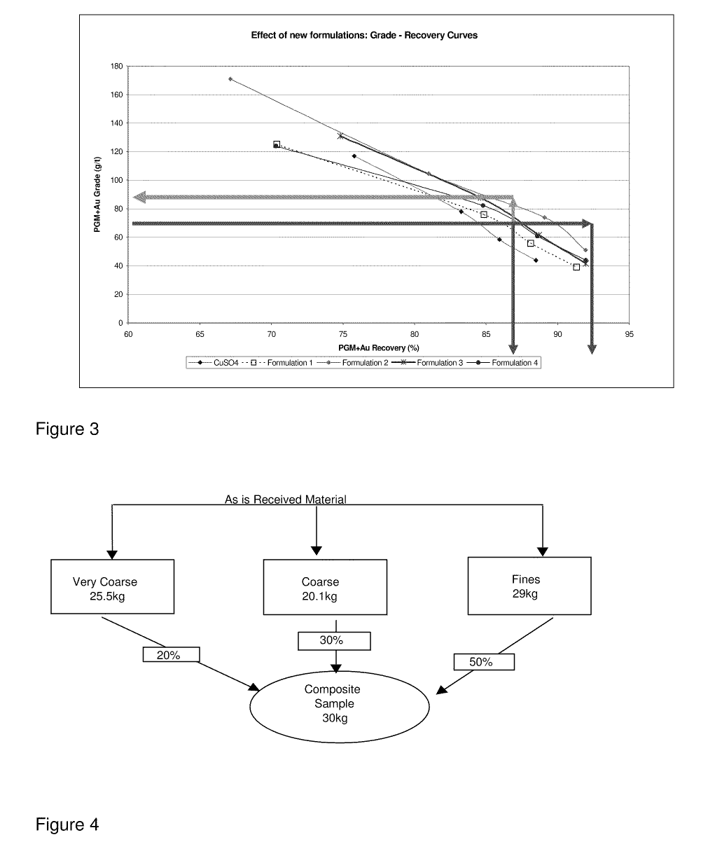

FIG. 3, termed the grade recovery curve from the test program of the copper chelate activator, was produced:

Referring to FIG. 3, the use of the formulation increases the mineral recovery, as per the red lines, for the same conventional copper sulphate and frother addition rates. Conversely, for the same recovery, the grade of the concentrate can be increased by adding less frother, as shown by the green lines in FIG. 3.

A further advantage of the invention is a reduction in the addition rate of depressant. The function of adding a depressant to the floatation process is to increase the final grade of the concentrate of the desired minerals by preventing the attachment of unwanted components or gangue contained in the ore to the air bubble of the froth. Referring to FIG. 3, the use of the formulation when compared to the use of standard copper sulphate, resulted in the production of a higher grade at the same recovery. The implication is that the formulation activates less of the unwanted components of the ore when compared to copper sulphate, used in the standard. The further implication is that less depressant needs to be added to control the grade of the desired mineral in the concentrate resulting in a saving in the costs of the depressant.

### EXAMPLE 6

In this example, the recovery of PGM and Au using an activator of the invention was investigated. Rougher rate tests with blank conditions (no copper sulphate) as well as with copper sulphate were done so as to serve as base case scenarios. The data produced suggested that the sample used had a high percentage of fast floating material, which would make it difficult to establish the effect of these new formulations. A low water recovery method of scraping the froth was adopted in the testwork program, as it produced better grades, whilst spreading the recovery over the entire float residence time.

It was concluded that the effect of the formulations of the invention is evident in the concentrate grades, and that they have particular contribution towards the overall recovery and the kinetics.

The Applicant developed a number of different activator formulations for use in various mineral flotation applications. After preliminary tests on these formulations, four with better performance on grade and flotation rate were selected for further tests.

### Sample Preparation

Three sample bags comprising very coarse material, coarse material and fine material respectively were used. All samples were sun-dried, individually crushed to 100% passing 1.7 mm using a cone crusher. A composite sample was made up as shown in FIG. 4. The composite sample was blended and split into 1 kg representative samples for testwork. Two 200 g sub-samples were extracted for duplicate head analysis of total PGM+Au.

### Determination of a Laboratory Milling Curve

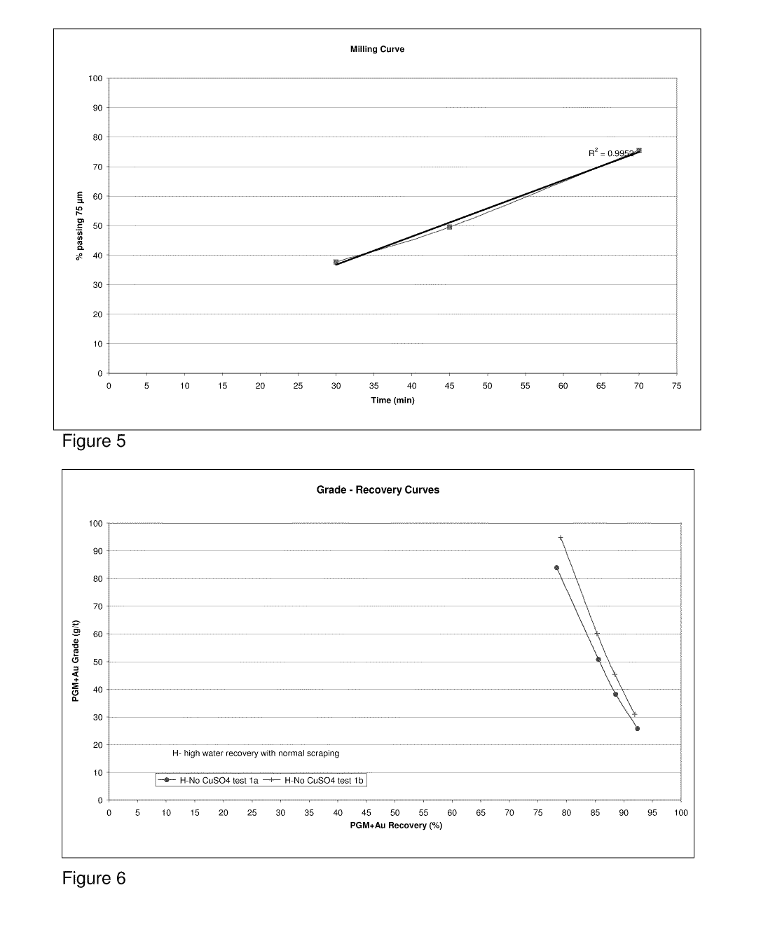

A milling curve was established by milling 1 kg sub-samples at different time intervals. The samples were milled at a solids content of 50% using a rubber-lined mill. The mill was 200 mm in diameter and 225 mm in length. The charge consisted of 10.96 kg of carbon rods. A three-point curve relating the ore fineness to milling time was plotted. The curve is presented in FIG. 5.

### Flotation Tests

### Reproducibility Test-Base Case

One set of duplicate tests was conducted to establish reproducibility. A 1 kg sample was milled in a rod mill to produce a grind of 60% passing 75 microns. The milled slurry was transferred to a 2.5 l float cell to make up slurry of approximately 35% solids. The slurry was then agitated intensively in a Denver D-12 machine with the speed set at 1200 rpm. Reagents were added and conditioned as specified in Table 7. Four concentrates were then collected over 0-1,1-3, 3-7 and 7-20 minutes. All the products were filtered, dried and sent for analysis by lead collection fire assay, gravimetric method (total PGM+Au).

TABLE 7
Standard reagent conditions

| | Dosage | Conditioning time |
|---|---|---|
| Reagent | (g/t) | (min) |
| SNPX | 130 | 2 |
| M49 | 112 | 3 |
| DOW 200 | 39 | 0.5 |

### Effect of New Formulation Tests

The effects of copper sulphate and the four formulations in accordance with the invention were investigated. With the copper sulphate tests, standard reagent conditions were adopted. The same reagent conditions were adopted for the remainder of the other tests with the respective substitution of the copper sulphate by one of the new formulations. The flotation procedure followed was the same as described hereinbefore. All products were analysed for total PGM and Au.

### Reproducibility and Scoping Tests

The main objective behind this test was to establish reproducibility of the data. FIG. 6 shows the total PGM recovery as a function of the grade. A final concentrate grade of about 30 g/t of PGM and Au was obtained. The results obtained showed that the PGM's were fast floating, yielding a 79% recovery in the first minute of flotation, and a total recovery of 92%.

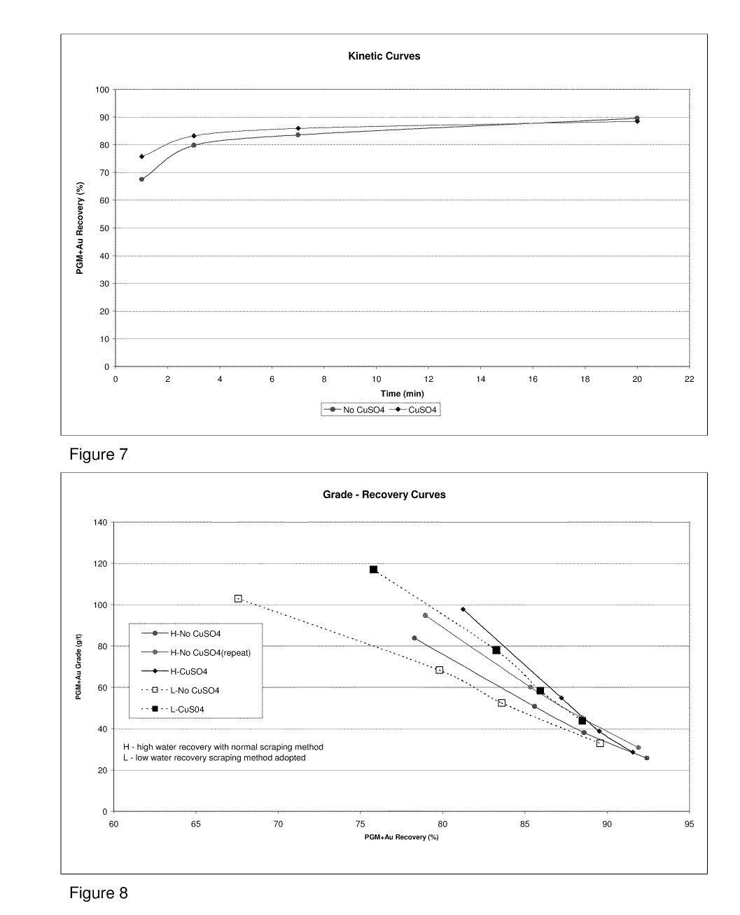

Due to the high concentrate recovery, it was suspected that the effect of the activators of the invention might be difficult to prove. A scoping test to prove this was conducted with copper sulphate. The results obtained showed 81% recovery after the first minute of flotation. Kinetic curves for both scenarios are presented in FIG. 7.

A different method of scraping the froth was proposed (low water recovery). With this method it was anticipated that the fast floating material would be slowed down, thus allowing the recovery to be spread throughout the entire residence time as opposed to the high water recovery method employed previously. Grade and recovery curves of these scoping tests are shown in FIG. 8.

From these results it was evident that the low water recovery method allows the fast floating material to be slowed down while stretching the recovery over the entire residence time, thereby to produce superior grades. It was consequently decided to use the low water recovery method of scraping the froth for the entire test program.

### Effect of New Formulations

The use of activators, including activators of the invention, as an addition to the base case tests (reproducibility tests) was investigated. Table shows the summary results of these tests.

TABLE 8
Effect of activators: Summary Results

| | | CuSO4 | Formulation 1 | Formulation 2 | Formulation 3 | Formulation 4 |
|---|---|---|---|---|---|---|
| Recovery | Conc 1 | 75.8 | 70.4 | 67.1 | 74.8 | 70.3 |
| | Conc 1 + 2 | 83.3 | 84.9 | 81 | 84.6 | 84.8 |
| | Conc 1 + 2 + 3 | 85.9 | 88.1 | 89.1 | 88.7 | 88.6 |
| | Conc 1 + 2 + 3 + 4 | 88.5 | 91.3 | 92 | 92 | 92 |
| Grades | Conc 1 | 117 | 125 | 171 | 131 | 124 |
| | Conc 1 + 2 | 78 | 75.78 | 104.58 | 87.83 | 82.25 |
| | Conc 1 + 2 + 3 | 58.41 | 55.78 | 73.92 | 61.65 | 61.04 |
| | Conc 1 + 2 + 3 + 4 | 43.87 | 39.13 | 51.02 | 41.63 | 43.84 |

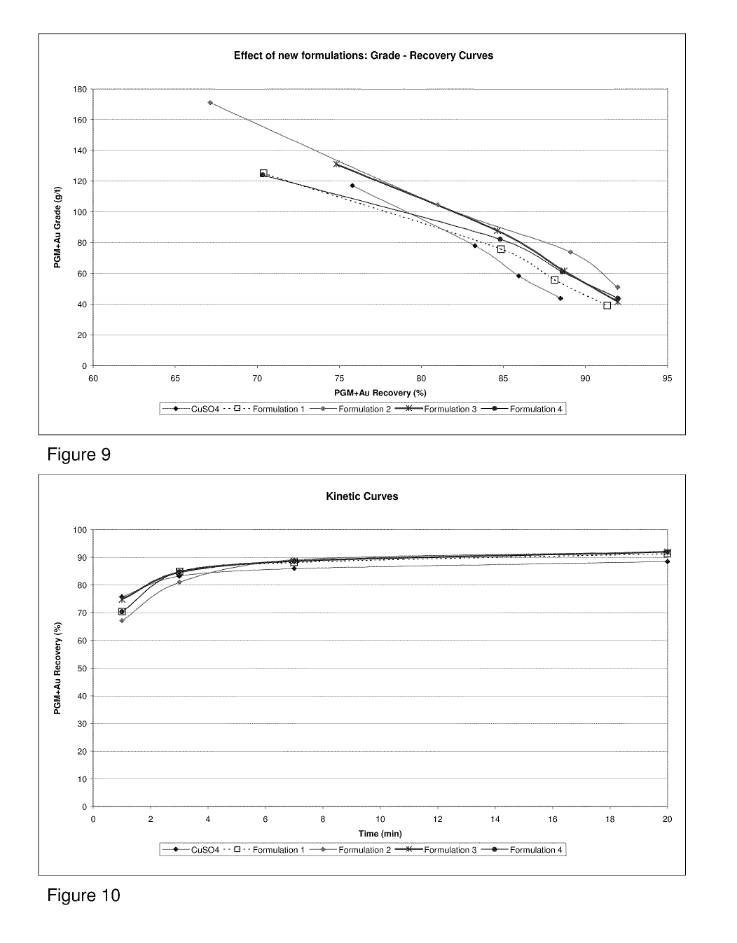

From these results it was evident that the new formulations had some effect on the overall recovery. Furthermore, slight differences in the grades were evident. FIG. 9 shows the grade and recovery curves. The results showed that the new activator formulations performed better than the copper sulphate control. Activator formulations 1 and 4 behaved in a similar manner, with the first concentrate grades at 124 g/t and 125 g/t respectively and total concentrate grades at 40 g/t and 44 g/t respectively. The performance of formulation 4, however, was not distinctly different from the ordinary copper sulphate test. Formulation 2 produced the best results, with the initial grade as high as 171 g/t and the total grade at 51 g/t. The order of performance of the formulations based on grade was as follows: Formulation 2>Formulation 3>Formulation 4>Formulation 1.

FIG. 10 shows the kinetic curves of all formulations and the copper sulphate base case. From these, it was evident that the formulations had a positive effect on the flotation kinetics of the ore used in these tests. The kinetics of formulation 3 was the best. The performance based on kinetics was ranked as follows: Formulation 3>Formulation 1>Formulation 4>Formulation 2.

### EXAMPLE 7

In this experiment the purpose was to determine which of the possible activators, which are mentioned below, can be used to chelate copper ions in flotation reactions and which are stable at a pH range from 1 to 12. This was done to ensure that the chelated compounds would not form precipitates in the high pH aqueous solutions found in ore flotation plants. It was, however, decided to test the chelated compounds over the entire pH range to check the stability over the whole pH range and thereby produce an activator that can be used in low pH conditions as well.

### Reagents and Equipment

All reagents were AR grade and were supplied by Merck Laboratory Supplies. The chelating agents were: acetic acid; ammonium sulphate; citric acid monohydrate; ethylenediaminetetraacetic acid (EDTA); ethylenediamine; monoethanolamine; oxalic acid; propylenediamine; sodium citrate; tartaric acid; and triethanolamine.

The other reagents that were used were: copper sulphate pentahydrate; water; pH 4 and pH 7 buffer solutions; sodium hydroxide; and sulphuric acid

### Setup and Procedure

A chelated copper solution was made up by adding 1 g of copper sulphate pentahydrate and a molar equivalent mass of a chelating agent to 100 ml of water in a 100 ml glass container. The solution was stirred on a magnetic stirrer until al the solids were dissolved. The chelated copper solution was inspected visually to see if any solids were present or if the chelating agent was incompatible with the copper sulphate. The final solution thus had a copper concentration of 0.25 g/100 ml or 2.5 g/l.

A Hanna pH meter was calibrated using pH 4 and pH 7 buffer solutions. A 1000 ml glass container was filled with deionised water and the pH was adjusted to 12 by adding sodium hydroxide to the water in increments while the water was stirred on a magnetic stirrer and the pH was measured with the Hanna pH meter. Thereafter, 100 ml of this pH 12 solution was added to three 100 ml glass containers. Following this, 1 ml of the chelated copper solution was added to each of the three pH 12 solutions which rendered a copper concentration of 0.025 g/l. The solution was visually inspected to see if any precipitates or liquid separation could be observed.

The solution was then filtered with a vacuum filter. The filter paper was weighed before use on the Mettler Toledo mass balance and the mass was noted. After the filtration of the solution the filter paper was visually inspected to see if there was any precipitate on it and it was then dried at 60° C. in an oven and weighed again with the mass being noted. This experiment was also repeated for pH levels of seven (unadjusted water) and one (water where the pH was lowered with sulphuric acid).

The purpose of this experiment was to find a chelated copper compound that was completely stable under the discussed conditions, i.e. a ligand that could complex with copper for use in flotation reactions across a wide range of pH values. Table 9 shows whether the activator of the invention, and in particular, the chelating agent/ligand, was stable at the selected pH values.

TABLE 9
Results of the stability experiments conducted on the various
chelated copper compounds

| | pH Stability | | |
|---|---|---|---|
| | Experiment | | |
| Chelating Agent | pH 12 | pH 7 | pH 1 |
| Acetic Acid | No | Yes | No |
| Ammonium Sulphate | No | Yes | No |
| Citric acid monohydrate | Yes | Yes | Yes |
| Ethylenediaminetetraacetic | Yes | Yes | Yes |
| Acid (EDTA) | | | |
| Ethylenediamine | Yes | Yes | Yes |
| Monoethanolamine | No | Yes | Yes |
| Oxalic Acid | No | No | No |
| Propylenediamine | Yes | Yes | Yes |
| Sodium Citrate | No | Yes | No |
| Tartaric Acid | No | Yes | No |
| Triethanolamine | Yes | Yes | Yes |

From the results above it is clear that oxalic acid is most likely not suitable for use as an activator of the invention. In a preferred embodiment, the following chelates/ligands, or combinations thereof, are usable to stabilize copper ions in solution: citric acid monohydrate, ethylenediamine tetraacetic acid (EDTA), ethylenediamine, propylenediamine and triethanolamine, as these chelates/ligands are also stabile at a pH of 1 and can therefore also be used as activators with copper in acidic conditions.

From the results presented hereinbefore it can be seen that the applicant has invented activators and activator formulations which have positive effects on the recovery and grades, as well as the kinetics of recovery, of mineral values. In addition, as pH plays a major role in ensuring sufficient flotation of mineral values, the pH performance of the activators of the invention ensure that the sufficient flotation can occur at various pH levels. In most cases, the activators and formulations of the invention produced better grades and recoveries than conventional copper sulphate used by itself.

The Applicant is of the opinion that it has developed a useful activator which can act as a froth modifier or promoter for the mining industry which may result in lower reagent use, particularly lower collector and depressant use. The activators work particularly well in ensuring that, especially, copper sulphate flotation reactions, proceed at increased rates and with lower copper sulphate use.

It shall be understood that the examples are provided for illustrating the invention further and to assist a person skilled in the art with understanding the invention and are not meant to be construed as unduly limiting the reasonable scope of the invention.

What is claimed is:

1. A flotation process, which includes the steps of:
in a minerals recovery plant, providing a flotation mixture containing mineral values to be recovered; and
adding an alkali-free activator to said flotation mixture, which activator comprises a metal complex formed by a coordinating metal ion and a ligand, wherein the molar ratio of ligand to metal ion is in a range of 2:1 to 1:2.

2. The flotation process as claimed in claim 1, wherein the molar ration of ligand to metal ion is about 1:1.

3. The flotation process as claimed in claim 1 which includes the step of forming adding individual components to the flotation mixture to form an activator complex in situ.

4. The flotation process as claimed in claim 1, wherein the ligand has the structure R—(X)ₙ, in which:
X is selected from amines, carboxyls, phosphonates and sulphonates;
R is an organic group; and
n is an integer from 1 to 4.

5. The flotation process as claimed in claim 4, wherein the ligand is a multidentate ligand.

6. The flotation process as claimed in claim 1, which includes the step of selecting a ligand which allows changes in a pH range to modify the charge or ionic nature of the ligand or complex, such that modifying the ligand charge or ionic nature renders it hydrophobic or hydrophilic as dictated by the process requirements.

7. The flotation process as claimed in claim 4, wherein the ligand is selected from any one or more of: adipic acid, alanine, aspartic acid, adenosine triphosphate, citric acid, cysteine, dimethylglyoxime, EDTA, gluconic acid, histidine, lactic acid, pimelic acid, salicylic acid, triphosphate, monoethanolamine, triethanolamine, 1,2-propylenediamine, tartaric acid, fulvic acid, sulphonic acid, and humic acid.

8. (canceled)

9. (canceled)

10. The flotation process as claimed in claim 1, wherein the activated metal is copper and the ligand is citric acid.

11. The flotation process as claimed in claim 1, which includes the step of selecting or adjusting the pH of the flotation mixture to change the hydrophobic or hydrophilic nature of the complex or to form a desired complex species.

12. The flotation process as claimed in claim 1, in which the following values are recovered:
Platinum Group Minerals (PGM) from platinum bearing ores;
Copper, Zinc, Lead, Silver, Gold recovery and separation from polymetallic and other base metal ores;
Gold and Silver from gold bearing ores; or
Sulphide minerals from sulphide containing ores.

13. The flotation process as claimed in claim 12, wherein the activator is added to the mixture in amounts ranging from 1 gram activator per one ton of ore to 1000 gram activator per one ton ore to be processed.

14. The flotation process as claimed in claim 13, wherein the activator is added to the mixture in amounts ranging from 50 to 150 grams activator per one ton of platinum bearing ore.

15. The flotation process as claimed in claim 12, wherein the activator is added to the mixture in amounts ranging from 150 to 250 grams activator per one ton of gold bearing ore.

16. The flotation process as claimed in claim 12, wherein the activator is added to the mixture in amounts ranging from 5 to 100 grams activator per one ton of zinc bearing ore.

17. (canceled)

18. An activator for use in a flotation process, comprising an alkaline free activator comprising a coordinating metal ion and a ligand which is complexed in an aqueous solution at a predetermined pH between pH 2 and pH 12.

19. (canceled)

20. The activator as claimed in claim 18, which is complexed in an aqueous solution at a predetermined pH of about pH 4.

21. (canceled)

22. The activator as claimed in claim 18, wherein the ligand has the structure R—(X)ₙ, in which:
X is selected from amines, carboxyls, phosphonates and sulphonates;
R is an organic group; and
n is an integer from 1 to 4.

23. The activator as claimed in claim 22, wherein the ligand is a multidentate ligand.

24. The activator as claimed in claim 18, wherein the ligand is a ligand which allows changes in a pH range to modify the charge or ionic nature of the ligand or complex, such that modifying the ligand charge or ionic nature renders it hydrophobic or hydrophilic as dictated by the process requirements.

25. The activator as claimed in claim 22, wherein the ligand is selected from any one or more of: adipic acid, alanine, aspartic acid, adenosine triphosphate, citric acid, cysteine, dimethylglyoxime, EDTA, gluconic acid, histidine, lactic acid, pimelic acid, salicylic acid, triphosphate, monoethanolamine, triethanolamine, 1,2-propylenediamine, tartaric acid, fulvic acid, sulphonic acid, and humic acid.

26. The activator as claimed in claim 18, wherein the molar ratio of ligand to metal ion is about 1:1.

27. The activator as claimed in claim 18 wherein the activator is copper citrate.

28. The activator as claimed in claim 18 for use in stabilizing the pH of a flotation process at about pH 4.

29. (canceled)

30. (canceled)
